(19) United States
(12) Patent Application Publication
(10) Pub. No.: US 2024/0391425 A1
(43) Pub. Date: Nov. 28, 2024

(54) SYSTEMS AND METHODS FOR WINDSHIELD WETTING DETECTION AND AUTO WIPING

(71) Applicant: Ford Global Technologies, LLC, Dearborn, MI (US)

(72) Inventors: Mahmoud Yousef Ghannam, Canton, MI (US); Robert Schroeter, Livonia, MI (US); Justin Miller, Berkley, MI (US); Anna Marie-Sophia Hoff, Köln (DE); Jeff Scott Lossing, Riverview, MI (US); Abdalla Abdel-Rahman, Dearborn, MI (US)

(73) Assignee: Ford Global Technologies, LLC, Dearborn, MI (US)

(21) Appl. No.: 18/323,349

(22) Filed: May 24, 2023

(51) Int. Cl. B60S 1/08

(52) U.S. Cl. CPC B60S 1/0844

(57) ABSTRACT

A vehicle having a windshield, a wiper and a vehicle camera is disclosed. The wiper may be configured to clean the windshield and the vehicle camera may be configured to capture a windshield image and a ground image. The vehicle may further include a processor that may obtain the windshield image and the ground image from the vehicle camera at a predefined sampling frequency. The processor may determine that the windshield and ground may be wet based on the windshield image and the ground image. The processor may actuate the wiper at a predefined speed based on a determination that both the windshield and the ground may be wet.

### FIELD

The present disclosure relates to systems and methods for windshield wetting detection and auto wiping and more particularly to systems and methods for facilitating windshield wetting detection and wiper speed control based on images captured by vehicle cameras.

### BACKGROUND

Vehicles typically include windshields through which vehicle drivers or occupants view surrounding areas. For example, a vehicle may include a front windshield through which a vehicle driver may view the road on which the vehicle may be travelling, and a rear windshield through which the vehicle driver may view objects in proximity to a vehicle rear side. The vehicle may additionally include wipers that may clean the windshields when rainwater, snow, etc. may be present on the windshields.

Modern vehicles additionally include dedicated rain sensors or rain sensing modules that detect presence of rainwater on the windshields. The rain sensors facilitate the vehicles in controlling wiper movement on the windshields. For example, the rain sensors may facilitate the vehicles in automatically activating and controlling wiper speed, when the rain sensors detect rainwater presence on the windshields.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts a block diagram of an example system to facilitate auto-wiping operation in accordance with the present disclosure.

FIG. 3 depicts a snapshot of an example vehicle with a plurality of sensors in accordance with the present disclosure.

FIG. 4 depicts a snapshot of an example vehicle in a covered enclosure in accordance with the present disclosure.

FIG. 5A depicts a snapshot of an example vehicle with wet windshield located on dry ground in accordance with the present disclosure.

FIG. 5B depicts a snapshot of an example vehicle with dry windshield located on wet ground in accordance with the present disclosure.

FIG. 6 depicts a flow diagram of an example method to facilitate auto-wiping in accordance with the present disclosure.

### DETAILED DESCRIPTION

### Overview

The present disclosure describes auto-wiping system and method for a vehicle. The vehicle may include a windshield, wipers configured to clean the windshield, and one or more vehicle cameras. The vehicle cameras may be configured to capture windshield images, vehicle surrounding images, and images of ground on which the vehicle may be located. The system may obtain images from the vehicle cameras at a predefined sampling frequency. The system may be configured to determine vehicle location and windshield wetness level based on the images obtained from the vehicle cameras, and may control wiper operation based on the vehicle location and the wetness level.

In some aspects, the system may determine whether the vehicle may be located inside a covered enclosure based on the images obtained from the vehicle cameras. The system may not activate wiper movement when the system determines that the vehicle may be located inside the covered enclosure. The system may further determine if at least one of the windshield and the ground may be dry based on the obtained images. The system may not activate wiper movement when the system determines that at least one of the windshield and the ground may be dry.

On the other hand, responsive to determining that the vehicle may be outside the covered enclosure and both the windshield and the ground may be wet based on the obtained images, the system may actuate the wiper at a predefined speed. The system may further determine if the wetness level may be increasing or decreasing with time, based on the images obtained from the vehicle cameras.

Responsive to determining that the wetness level may be increasing, the system may increase wiper speed. The system may further increase the sampling frequency at which the system may be obtaining images from the vehicle cameras. Similarly, the system may decrease the wiper speed and the sampling frequency responsive to determining that the wetness level may be decreasing.

The system may further determine if the vehicle may be stationary for a time duration greater than a predefined threshold. The system may decrease the sampling frequency (and/or the wiper speed) when the system determines that the vehicle may be stationary for a time duration greater than the predefined threshold.

In some aspects, the vehicle may include additional sensors, e.g., microphones, Global Position System (GPS) sensors/receivers, etc. The system may obtain inputs from the additional sensors, in addition to obtaining images from the vehicle cameras, to determine the vehicle location and the wetness level.

The present disclosure discloses system and method for auto-wiping in a vehicle. The system uses images obtained from vehicle cameras to control wiper movement, and may hence not require conventional rain sensing modules to control wiper movement. The system further decreases sampling frequency at which the system may obtain images from the vehicle cameras when the wetness level on the windshield may be less, thus conserving system computational resources. Furthermore, the system may not activate wiper movement when the vehicle may be located in a covered enclosure, thus conserving vehicle energy consumption when wiper movement may not be required.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

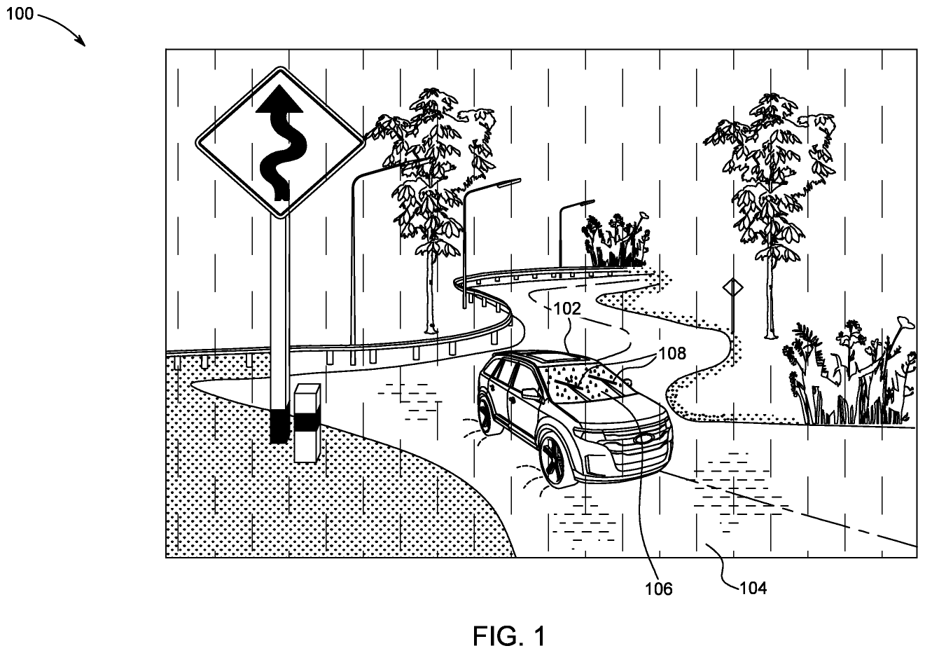

FIG. 1 depicts an example environment 100 in which techniques and structures for providing the systems and methods disclosed herein may be implemented. The environment 100 may include a vehicle 102 that may take the form of any passenger or commercial vehicle such as, for example, a car, a work vehicle, a crossover vehicle, a truck, a van, a minivan, a taxi, a bus, etc. The vehicle 102 may be a manually driven vehicle, and/or may be configured to operate in a partially autonomous mode, and may include any powertrain such as, for example, a gasoline engine, one or more electrically-actuated motor(s), a hybrid system, etc. The vehicle 102 may be travelling on a road 104, which may be wet as shown in FIG. 1. In an exemplary aspect, the road 104 may be wet due to rain, snowfall (e.g., due to melted snow), hail storm, thunderstorm, etc.

The vehicle 102 may include a front windshield 106 and a rear windshield (not shown). The front windshield 106 and the rear windshield too may be wet due to rain, as shown in FIG. 1. The vehicle 102 may further include front wipers 108 (or wipers 108) that may be configured to clean the front windshield 106, and rear wipers (not shown) that may be configured to clean the rear windshield.

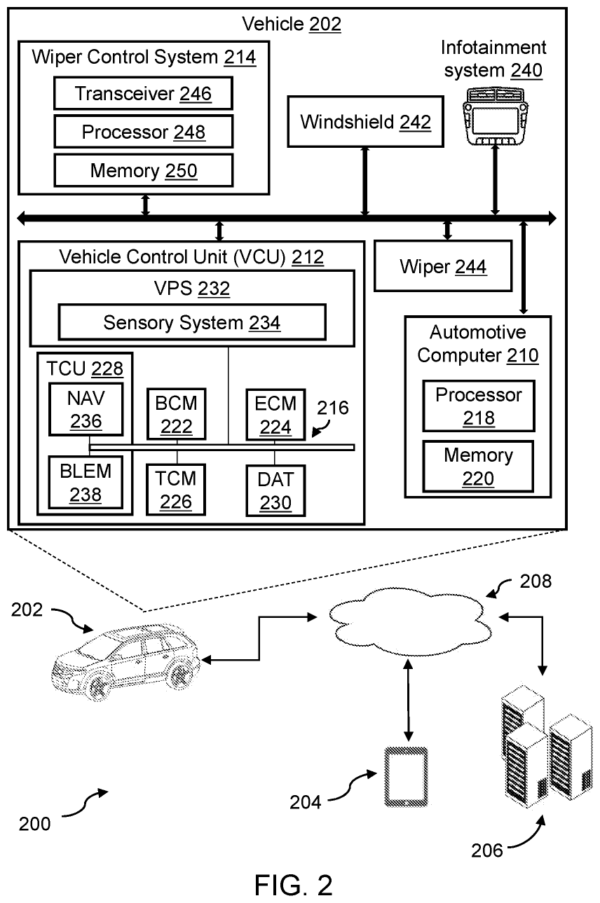

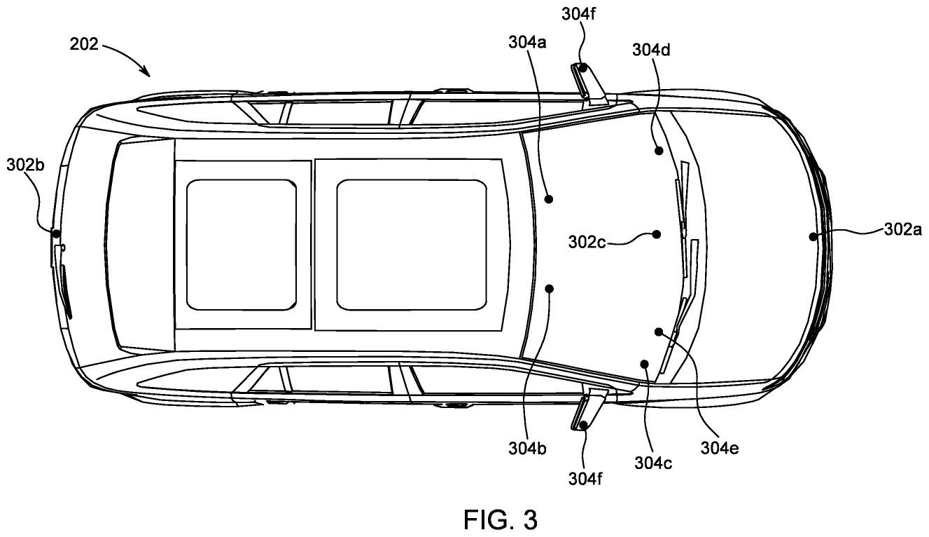

The vehicle 102 may further include one or more vehicle cameras and sensors (described in detail below in conjunction with FIGS. 2 and 3) that may be configured to capture images, sound signals, and/or determine ambient environmental conditions in vehicle vicinity. When a vehicle operator (not shown) activates vehicle ignition (i.e., when the vehicle operator performs Key ON operation), the vehicle 102 may start to obtain inputs from the vehicle cameras (and the sensors) at a first predefined sampling frequency. The vehicle 102 may be configured to automatically control wiper movement based on inputs obtained from the vehicle cameras (and the sensors).

For example, in some aspects, the vehicle 102 may automatically control wiper activation or deactivation operation based on vehicle location and wetness level on the windshield and/or the road 104 on which the vehicle 102 may be located. In an exemplary aspect, the vehicle 102 may deactivate or keep wiper “auto-wiping” operation OFF when the vehicle 102 may be located in a covered enclosure. For example, the vehicle 102 may not activate wiper movement when the vehicle 102 may be parked in home parking. The vehicle 102 may determine that the vehicle 102 may be parked in the home parking (i.e., in a covered enclosure) based on images obtained from vehicle exterior cameras and/or real-time vehicle geolocation obtained from vehicle geolocation module/Global Positioning System (GPS) receivers or sensors.

The vehicle 102 may further determine whether the front windshield 106 (and/or the rear windshield) may be wet, or the road 104 may be wet, or both the front windshield 106 and the road 104 may be wet, based on the inputs obtained from the vehicle cameras and/or sensors when the vehicle 102 may be outside of the covered enclosure. The vehicle 102 may keep the wiper “auto-wiping” operation OFF when the vehicle 102 determines that only the front windshield 106 (and/or the rear windshield) may be wet, or only the road 104 may be wet, or both may be dry. Stated another way, the vehicle 102 may not activate the wiper movement when the vehicle 102 determines that at least one of the front windshield 106 (and/or the rear windshield) and the road 104 may be dry.

In some aspects, the vehicle 102 may activate the wiper movement when the vehicle 102 determines that both the front windshield 106 (and/or the rear windshield) and the road 104 or the ground on which the vehicle 102 may be located may be wet, and the vehicle 102 may be outside of the covered enclosure. Responsive to such determination, the vehicle 102 may activate the wipers 108 at a first predefined speed. The vehicle 102 may further continue to obtain the inputs from the vehicle cameras (and the sensors) at the first predefined sampling frequency when the vehicle activates the wiper movement at the first predefined speed.

The vehicle 102 may determine wetness level on the front windshield 106 (and/or the rear windshield) based on the obtained inputs, and may determine if the wetness level is increasing, decreasing or remaining steady/same with time. The wetness level may be determined based on water droplet size on the front windshield 106 (and/or the rear windshield), droplet shape, water stream flow shape on the front windshield 106 (and/or the rear windshield), water level on the ground/road 104, as determined based on the inputs obtained from the vehicle cameras (and the sensors). Responsive to determining that the wetness level may be increasing with time, the vehicle 102 may increase wiper speed (e.g., to a second predefined speed) from the first predefined speed. In this case, the vehicle 102 may also increase the frequency at which the vehicle 102 may be obtaining inputs from the vehicle cameras from the first predefined sampling frequency to a second (higher) predefined sampling frequency.

On the other hand, responsive to determining that the wetness level may be decreasing with time, the vehicle 102 may decrease wiper speed (e.g., to a third predefined speed) from the first predefined speed. In this case, the vehicle 102 may also decrease the frequency at which the vehicle 102 may be obtaining inputs from the vehicle cameras from the first/second predefined sampling frequency to a third (lower) predefined sampling frequency.

In an exemplary aspect, the vehicle 102 may keep the wiper speed constant at the first predefined speed when the wetness level may be remaining steady/same with time. In other aspects, the vehicle 102 may still increase the wiper speed when the wetness level may be remaining steady/same with time. In additional aspects, the vehicle 102 may deactivate wiper movement when the vehicle 102 determines no wetness (or zero wetness level) on the front windshield 106 (and/or the rear windshield).

In some aspects, the vehicle 102 may use Artificial Intelligence (AI)/Machine Learning (ML) algorithms and pre-stored training data to determine optimal wiper speed based on wetness level on the front windshield 106 (and/or the rear windshield). For example, the vehicle 102 may determine the first predefined speed, the second predefined speed and the third predefined speed described above, based on AI/ML algorithms, pre-stored training data and the wetness level on the front windshield 106 (and/or the rear windshield). The vehicle 102 may similarly determine the first, second and third sampling frequencies described above based on AI/ML algorithms, pre-stored training data and the wetness level on the front windshield 106 (and/or the rear windshield).

In additional aspects, the vehicle 102 may decrease (or deactivate) wiper speed and decrease sampling frequency of inputs obtained from the vehicle cameras when the vehicle 102 may not move for more than a predefined time duration. For example, if the vehicle 102 may be stationary for more than 2 minutes, the vehicle 102 may decrease wiper speed and sampling frequency to conserve vehicle energy.

Further details of vehicle auto-wiping operations are described below in conjunction with FIG. 2.

The vehicle 102 and/or the vehicle operator implement and/or perform operations, as described here in the present disclosure, in accordance with the owner manual and safety guidelines.

FIG. 2 depicts a block diagram of an example system 200 to facilitate auto-wiping operation in accordance with the present disclosure. While describing FIG. 2, references may be made to FIGS. 3, 4, 5A and 5B.

The system 200 may include a vehicle 202, a user device 204, and one or more servers 206 communicatively coupled with each other via one or more networks 208. The vehicle 202 may be same as the vehicle 102 described in conjunction with FIG. 1. The user device 204 may be associated with the vehicle operator, and may include, but is not limited to, a mobile phone, a laptop, a computer, a tablet, a wearable device, or any other similar device with communication capabilities. The server(s) 206 may be part of a cloud-based computing infrastructure and may be associated with and/or include a Telematics Service Delivery Network (SDN) that provides digital data services to the vehicle 202 and other vehicles (not shown in FIG. 2) that may be part of a commercial vehicle fleet. In further aspects, the server(s) 206 may provide real-time weather condition information to the vehicle 202 and other vehicles operating as part of the vehicle fleet. The weather condition information may include information associated with presence, absence and/or level of rain or snow, ambient temperature, and/or the like in a geographical area where the vehicle 202 may be located. In additional aspects, the server(s) 206 may provide training data including correlation between one or more wetness levels on vehicle windshield (e.g., the front windshield 106) with optimal wiper speeds or sampling frequencies of obtaining inputs from vehicle cameras. The training data is described later in detail in the description below.

The network(s) 208 illustrates an example communication infrastructure in which the connected devices discussed in various embodiments of this disclosure may communicate. The network(s) 208 may be and/or include the Internet, a private network, public network or other configuration that operates using any one or more known communication protocols such as, for example, transmission control protocol/Internet protocol (TCP/IP), Bluetooth®, BLE®, Wi-Fi based on the Institute of Electrical and Electronics Engineers (IEEE) standard 802.11, UWB, and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The vehicle 202 may include a plurality of units including, but not limited to, an automotive computer 210, a Vehicle Control Unit (VCU) 212, and a wiper control system 214. The VCU 212 may include a plurality of Electronic Control Units (ECUs) 216 disposed in communication with the automotive computer 210.

The user device 204 may connect with the automotive computer 210 and/or the wiper control system 214 via the network 208, which may communicate via one or more wireless connection(s), and/or may connect with the vehicle 202 directly by using near field communication (NFC) protocols, Bluetooth® protocols, Wi-Fi, Ultra-Wide Band (UWB), and other possible data connection and sharing techniques.

In some aspects, the automotive computer 210 and/or the wiper control system 214 may be installed in a vehicle engine compartment (or elsewhere in the vehicle 202), in accordance with the disclosure. Further, the automotive computer 210 may operate as a functional part of the wiper control system 214. The automotive computer 210 may be or include an electronic vehicle controller, having one or more processor(s) 218 and a memory 220. Moreover, the wiper control system 214 may be separate from the automotive computer 210 (as shown in FIG. 2) or may be integrated as part of the automotive computer 210.

The processor(s) 218 may be disposed in communication with one or more memory devices disposed in communication with the respective computing systems (e.g., the memory 220 and/or one or more external databases not shown in FIG. 2). The processor(s) 218 may utilize the memory 220 to store programs in code and/or to store data for performing aspects in accordance with the disclosure. The memory 220 may be a non-transitory computer-readable memory storing a wiper control program code. The memory 220 can include any one or a combination of volatile memory elements (e.g., dynamic random-access memory (DRAM), synchronous dynamic random-access memory (SDRAM), etc.) and can include any one or more nonvolatile memory elements (e.g., erasable programmable read-only memory (EPROM), flash memory, electronically erasable programmable read-only memory (EEPROM), programmable read-only memory (PROM), etc.).

In accordance with some aspects, the VCU 212 may share a power bus with the automotive computer 210 and may be configured and/or programmed to coordinate the data between vehicle 202 systems, connected servers (e.g., the server(s) 206), and other vehicles (not shown in FIG. 2) operating as part of a vehicle fleet. The VCU 212 can include or communicate with any combination of the ECUs 216, such as, for example, a Body Control Module (BCM) 222, an Engine Control Module (ECM) 224, a Transmission Control Module (TCM) 226, a telematics control unit (TCU) 228, a Driver Assistances Technologies (DAT) controller 230, etc. The VCU 212 may further include and/or communicate with a Vehicle Perception System (VPS) 232, having connectivity with and/or control of one or more vehicle sensory system(s) 234. The vehicle sensory system 234 may include one or more vehicle sensors including, but not limited to, a Radio Detection and Ranging (RADAR or “radar”) sensor configured for detection and localization of objects inside and outside the vehicle 202 using radio waves, sitting area buckle sensors, sitting area sensors, a Light Detecting and Ranging (LiDAR or “lidar”) sensor, door sensors, proximity sensors, temperature sensors, wheel sensors, ambient weather sensors, vehicle internal and external cameras, etc. An example snapshot/top view of the vehicle 202 with the one or more sensors described here is shown in FIG. 3.

As shown in FIG. 3, the vehicle 202 may include a front camera 302a, a rear camera 302b and a front/forward dash camera 302c (collectively referred to as vehicle cameras 302). The front camera 302a may be configured to capture images in front of the vehicle 202 and of the ground/road 104 on which the vehicle 202 may be located. The rear camera 302b may be configured to capture images of vehicle rear side and of the ground/road 104. The front dash camera 302c may be configured to capture images of vehicle front windshield (e.g., the front windshield 106) and of the ground/road 104. Collectively, the vehicle cameras 302 may be configured to capture images of areas in front and back side of the vehicle 202, vehicle windshields, and the ground on which the vehicle 202 may be located.

The vehicle 202 may include additional cameras and sensors, as shown in FIG. 3. Examples of such additional cameras and sensors include, but are not limited to, a built-in microphone 304a, an external microphone 304b, an external rain sensor 304c, a built-in GPS sensor/receiver 304d, an external GPS sensor/receiver 304e, mirror cameras 304f, a rear dash camera (not shown), and/or the like (collectively referred to as additional sensors 304).

In some aspects, the VCU 212 may control vehicle operational aspects and implement one or more instruction sets received from the user device 204, from one or more instruction sets stored in the memory 220, including instructions operational as part of the wiper control system 214.

The TCU 228 may be configured and/or programmed to provide vehicle connectivity to wireless computing systems onboard and off board the vehicle 202, and may include a Navigation (NAV) receiver 236 (which may be same as GPS sensors/receivers 304d, 304e) for receiving and processing a GPS signal, a BLE® Module (BLEM) 238, a Wi-Fi transceiver, a UWB transceiver, and/or other wireless transceivers (not shown in FIG. 2) that may be configurable for wireless communication between the vehicle 202 and other systems (e.g., a vehicle key fob, not shown in FIG. 2), computers, and modules. The TCU 228 may be disposed in communication with the ECUs 216 by way of a bus.

The ECUs 216 may control aspects of vehicle operation and communication using inputs from human drivers, inputs from an autonomous vehicle controller, the wiper control system 214, and/or via wireless signal inputs received via the wireless connection(s) from other connected devices, such as the user device 204, the server(s) 206, among others.

The BCM 222 generally includes integration of sensors, vehicle performance indicators, and variable reactors associated with vehicle systems, and may include processor-based power distribution circuitry that can control functions associated with the vehicle body such as lights, windows, security, camera(s), audio system(s), speakers, wipers, door locks and access control, and various comfort controls. The BCM 222 may also operate as a gateway for bus and network interfaces to interact with remote ECUs (not shown in FIG. 2).

The DAT controller 230 may provide Level-1 through Level-3 automated driving and driver assistance functionality that can include, for example, active parking assistance, vehicle backup assistance, adaptive cruise control, and/or lane keeping, among other features. The DAT controller 230 may also provide aspects of user and environmental inputs usable for user authentication.

In some aspects, the automotive computer 210 may connect with an infotainment system 240. The infotainment system 240 may include a touchscreen interface portion, and may include voice recognition features, biometric identification capabilities that can identify users based on facial recognition, voice recognition, fingerprint identification, or other biological identification means. In other aspects, the infotainment system 240 may be further configured to receive user instructions via the touchscreen interface portion, and/or display notifications, navigation maps, etc. on the touchscreen interface portion.

The vehicle 202 may further include a windshield 242 and a wiper 244. The windshield 242 may be same as the front windshield 106 and/or the rear windshield, and the wiper 244 may be same as the wipers 108. The automotive computer 210 and/or the wiper control system 214 may control wiper operation and movement via the BCM 222.

The computing system architecture of the automotive computer 210, the VCU 212, and/or the wiper control system 214 may omit certain computing modules. It should be readily understood that the computing environment depicted in FIG. 2 is an example of a possible implementation according to the present disclosure, and thus, it should not be considered limiting or exclusive.

In accordance with some aspects, the wiper control system 214 may be integrated with and/or executed as part of the ECUs 216. The wiper control system 214, regardless of whether it is integrated with the automotive computer 210 or the ECUs 216, or whether it operates as an independent computing system in the vehicle 202, may include a transceiver 246, a processor 248, and a computer-readable memory 250.

The transceiver 246 may be configured to receive information/inputs from one or more external devices or systems, e.g., the user device 204, the server(s) 206, and/or the like via the network 208. Further, the transceiver 246 may transmit notifications (e.g., alert/alarm signals) to the external devices or systems. In addition, the transceiver 246 may be configured to receive information/inputs from vehicle 202 components such as the infotainment system 240, the vehicle sensory system 234 (including the cameras and sensors depicted in FIG. 3), and/or the like. Further, the transceiver 246 may transmit notifications (e.g., alert/alarm signals) to the vehicle 202 components such as the infotainment system 240, the BCM 222, etc.

The processor 248 and the memory 250 may be same as or similar to the processor 218 and the memory 220, respectively. In some aspects, the processor 248 may be an AI/ML based processor that may utilize the memory 250 to store programs in code and/or to store data for performing aspects in accordance with the disclosure. The memory 250 may be a non-transitory computer-readable memory storing the wiper control code. In some aspects, the memory 250 may additionally store information associated with the vehicle 202 and one or more sensory inputs received from the sensory system 234 (e.g., the cameras and sensors depicted in FIG. 3). In additional aspects, the memory 250 may store the training data including correlation between one or more wetness levels on the windshield 242 with optimum wiper speeds or sampling frequencies of obtaining inputs from the vehicle cameras 302. The usage of training data is described below.

In operation, the processor 248 may determine, via the VCU 212, that the vehicle operator may have started vehicle ignition or performed Key ON operation. Responsive to determining the Key ON operation, the processor 248 may initiate an “initialization mode” of the wiper control system 214. In the initialization mode, the processor 248 may obtain inputs from the vehicle cameras 302 at a first sampling frequency. Specifically, in the initialization mode, the processor 248 may begin to obtain images of areas in front and rear side of the vehicle 202, and images of the windshield 242 at the first sampling frequency. In addition, the processor 248 may obtain inputs from the additional sensors 304 at the first sampling frequency.

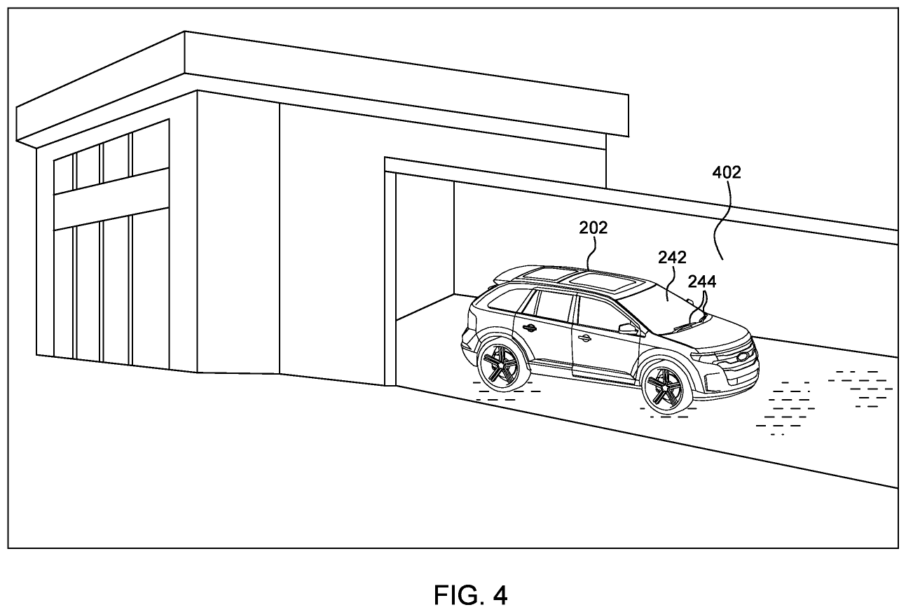

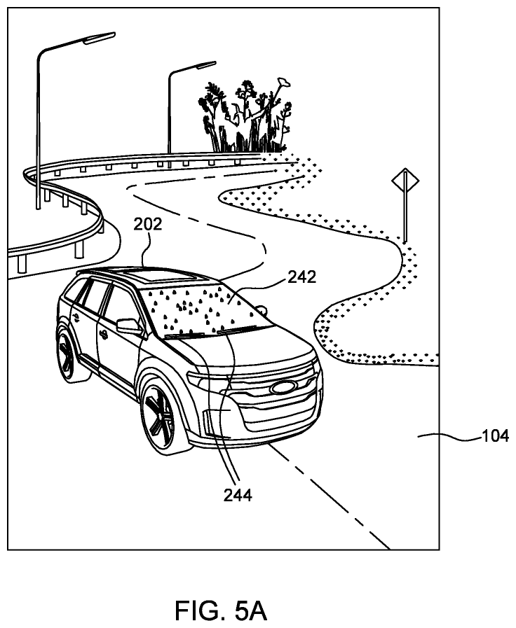

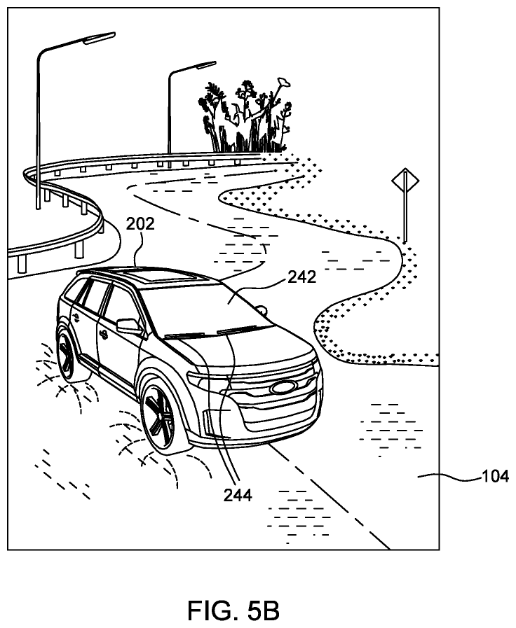

Responsive to obtaining the inputs from the vehicle cameras 302, the processor 248 may determine whether the vehicle 202 may be located inside or outside a covered enclosure (e.g., a parking area), and whether the windshield 242 and/or the ground on which the vehicle 202 may be located may be wet or dry. An exemplary snapshot of the vehicle 202 stationed/located in a covered enclosure 402 is shown in FIG. 4. The covered enclosure 402 may be a home parking, an office parking, a shade under which the vehicle operator may have parked the vehicle 202, and/or the like. Exemplary snapshots of the vehicle 202 located outside the covered enclosure (e.g., travelling on the road 104) is shown in FIGS. 5A and 5B.

In some aspects, the processor 248 may determine whether the vehicle 202 may be located inside or outside the covered enclosure 402 based on inputs (e.g., images) obtained from the vehicle cameras 302. In other aspects, the processor 248 may determine whether the vehicle 202 may be located inside or outside the covered enclosure 402 based on inputs obtained from the additional sensors 304. For example, the processor 248 may determine whether the vehicle 202 may be located inside or outside the covered enclosure 402 based on real-time vehicle location obtained from the GPS sensors/receivers 304d, 304e.

Similarly, the processor 248 may determine whether the windshield 242 and/or the ground on which the vehicle 202 may be located may be wet or dry based on inputs (e.g., images) obtained from the vehicle cameras 302. In additional aspects, the processor 248 may determine whether the windshield 242 and/or the ground on which the vehicle 202 may be located may be wet or dry based on inputs obtained from the additional sensors 304, and/or inputs received from external devices. For example, the processor 248 may determine that the windshield 242 or the ground may be wet based on weather condition information obtained from the server 206, sound signals obtained from the microphones 304a, 304b (e.g., when rain drops may be falling on the windshield 242), inputs received from other vehicles (e.g., via V2V communication) that may be part of vehicle fleet, inputs received from external sensors (e.g., via vehicle-to-infrastructure communication) that may be installed in proximity to the vehicle 202, and/or the like.

Responsive to determining vehicle location state (i.e., whether the vehicle 202 may be located inside or outside the covered enclosure 402) and windshield 242 and ground wetness states, the processor 248 may control wiper movement. In an exemplary aspect, the processor 248 may not actuate wiper movement when the processor 248 determines that the vehicle 202 may be located inside the covered enclosure 402, irrespective of whether the windshield 242 and/or the ground may be wet. For example, in the exemplary aspect depicted in FIG. 4, the processor 248 may not actuate the wiper movement, as the vehicle 202 is parked inside the covered enclosure 402.

On the other hand, responsive to determining that the vehicle 202 may be located outside the covered enclosure 402, the processor 248 may determine whether only the windshield 242 may be wet and the road 104 may be dry (as shown in FIG. 5A), or only the road 104 may be wet and the windshield 242 may be dry (as shown in FIG. 5B). The processor 248 may not actuate the wiper movement when either of the scenarios depicted in FIG. 5A or FIG. 5B may be detected by the processor 248. Stated another way, the processor 248 may not actuate the wiper movement when either of the windshield 242 and the road 104 may be dry.

The processor 248 may actuate the wiper movement when the processor 248 determines that both the windshield 242 and the road 104 may be wet. Specifically, the processor 248 may actuate the wiper 244 at a first speed responsive to determining that both the windshield 242 and the road 104 may be wet. In some aspects, the processor 248 may further determine, via inputs obtained from the sensory system 234 and/or weather condition information obtained from the server 206, that ambient temperature in proximity to the vehicle 202 may be more than 0 degrees (i.e., water freezing point). The processor 248 may actuate the wiper movement when the ambient temperature may be more than 0 degrees (so that rainwater or snow may be in liquid state) and may not actuate the wiper movement when the ambient temperature may be equal to or less than 0 degrees.

The processor 248 may continue to move the wiper 244 at the first speed and obtain inputs from the vehicle cameras 302 (and the additional sensors 304) at the first sampling frequency till the processor 248 determines that the vehicle 202 may be moving. The processor 248 may determine that the vehicle 202 may be moving based on the real-time vehicle location obtained from the GPS sensors/receivers 304d, 304e, and/or inputs obtained from the VCU 212.

Responsive to determining that the vehicle 202 may be moving, the processor 248 may initiate a “wetting detection mode” of the wiper control system 214. In some aspects, the processor 248 may initiate the “wetting detection mode” when the vehicle 202 starts to move, irrespective of whether the wiper 244 was moving (at the first speed) or stationary in the “initialization mode”.

In the “wetting detection mode”, the processor 248 may obtain the inputs from the vehicle cameras 302 (and the additional sensors 304) at a second sampling frequency. In some aspects, the second sampling frequency may be same as the first sampling frequency. In other aspects, the second sampling frequency may be different from (e.g., more or less than) the first sampling frequency. Responsive to obtaining the inputs, the processor 248 may again determine whether the vehicle 202 may be inside a covered enclosure (e.g., travelling in a tunnel) or outside. Further, the processor 248 may determine whether either of the windshield 242 or the road 104 may be dry, as described above.

Responsive to determining that the vehicle 202 may be outside the covered enclosure and both the windshield 242 and the road 104 may be wet, the processor 248 may actuate the wiper 244 at a second speed. In some aspects, the second speed may be same as the first speed. In other aspects, the second speed may be different from the first speed.

The processor 248 may continue to operate the wiper control system 214 in the “wetting detection mode” and obtain inputs from the vehicle cameras 302 (and the additional sensors 304) as the vehicle 202 travels or moves on the road 104. The processor 248 may determine wetness levels of the windshield 242 (or vehicle surrounding) based on the obtained inputs, and may adjust wiper speed and sampling frequency of obtaining inputs from the vehicle cameras 302 (and the additional sensors 304) based on the determined wetness levels, as described below.

The processor 248 may determine wetness levels at a plurality of timestamps and may determine whether the wetness levels may be increasing or decreasing with time. For example, the processor 248 may determine a first wetness level of the windshield 242 (or vehicle surrounding) at a first timestamp, “T=T1”. In some aspects, the processor 248 may determine the first wetness level based on the windshield image and ground/road image obtained from the vehicle cameras 302. In other aspects, the processor 248 may additionally determine the first wetness level based on inputs obtained from the microphones 304a, 304b (e.g., based on detected decibel levels of raindrops, when the vehicle 202 may be travelling through a geographical area having rainfall), vehicle ambient weather sensors, piezoelectric sensors, and/or weather condition information obtained from the server 206 (that may provide weather condition information to the vehicle 202 based on vehicle real-time location).

In some aspects, the processor 248 may determine the first wetness level based on one or more of a water droplet size on the windshield 242, a droplet shape on the windshield 242, water stream flow shape and size on the windshield 242, decibel levels of raindrops, water level on the ground/road 104, and/or the like. In some aspects, the processor 248 may use AI/ML based algorithms (that may be stored in the memory 250) and a first training dataset that may be stored in the memory 250 (and/or obtained from the server 206) to determine the first wetness level. The AI/ML based algorithms may be supervised learning based algorithms. In an exemplary aspect, the first training dataset may include correlations between defined wetness levels (e.g., wetness levels “Low”, “low medium”, “medium”, “high medium”, “high”, and/or the like) with preset water droplet sizes, shapes, raindrop decibel levels, ground water level, etc. The processor 248 may compare the determined water droplet sizes, shapes, raindrop decibel levels, ground water level, etc. with respective preset values stored in the memory 250 to determine the first wetness level (as low, medium, high, etc.).

Similar to determining the first wetness level at the first timestamp “T=T1”, the processor 248 may determine a second wetness level at the second timestamp “T=T2”. In an exemplary aspect, T1 and T2 may correspond to the sampling frequency (e.g., the second sampling frequency) at which the processor 248 may be obtaining inputs from the vehicle cameras 302 and the additional sensors 304. Responsive to determining the first and the second wetness levels, the processor 248 may compare the first wetness level and the second wetness level to determine whether the wetness level of the windshield 242 may be increasing, decreasing or remaining the same. For example, the processor 248 may determine that the wetness level may be increasing when the second wetness level may be greater than the first wetness level. Similarly, the processor 248 mat determine that the wetness level may be decreasing when the second wetness level may be less than the first wetness level.

Responsive to determining that the second wetness level may be greater than the first wetness level, the processor 248 may increase the wiper speed from the second speed to a third (higher) speed. The processor 248 may further increase the second sampling frequency to a third (higher) sampling frequency responsive to determining that the second wetness level may be greater than the first wetness level.

In some aspects, the processor 248 may keep the wiper speed and the sampling frequency same (or may increase) when the processor 248 determines that the second wetness level may be equivalent to the first wetness level.

On the other hand, responsive to determining that the second wetness level may be less than the first wetness level, the processor 248 may decrease the wiper speed from the second speed to a fourth (lower) speed. The processor 248 may further decrease the second sampling frequency to a fourth (lower) sampling frequency responsive to determining that the second wetness level may be less than the first wetness level.

A person ordinarily skilled in the art may appreciate that increasing the wiper speed when the wetness level (or rainfall intensity) may be increasing on the windshield 242 enhances user convenience of operating the vehicle 202. Further, increasing the sampling frequency ensures that the processor 248 determines further wetness levels (at subsequent timestamps T3, T4, T5, etc.) more frequently, and hence provides better and faster wiper speed control when the rainfall intensity may be high. Similarly, decreasing the sampling frequency when the wetness level (and hence the rainfall intensity) may be decreasing ensures that the processor 248 saves computational resources.

In some aspects, the processor 248 may determine the second speed, the third speed, the fourth speed, etc.; and the second sampling frequency, the third sampling frequency, the fourth sampling frequency, etc. described above based on AI/ML algorithms (that may be stored in the memory 250) and a second training dataset that may be stored in the memory 250 (and/or obtained from the server 206). In an exemplary aspect, the second training dataset may include correlations between defined wiper speeds (e.g., the second, the third and the fourth speeds) with preset wetness levels. Similarly, the second training dataset may include correlations between defined sampling frequencies (e.g., the second, the third and the fourth sampling frequencies) with preset wetness levels. For example, the second training dataset may include correlation indicating that the wiper 244 may be moved at the first or the second speed when the wetness level may be low or medium (e.g., when the windshield 242 may be wet due to a sprinkler system that may have sprinkled water on the windshield 242, water splash from another vehicle travelling in proximity to the vehicle 202, snow, etc.). The second training dataset may further include correlation indicating that the wiper 244 may be moved at a higher speed when the wetness level may be high (e.g., when the windshield 242 may be wet due to high-intensity rain).

In some aspects, the server 206 may update the first training dataset and the second training dataset at regular or predefined time durations, and may provide updated training datasets to the vehicle 202 (and other vehicles that may be part of a vehicle fleet), so that the processor 248 may use updated training datasets to determine optimal wiper speeds and sampling frequencies.

In further aspects, when the wiper control system 214 may be operating in the “wetting detection mode”, the processor 248 may be configured to determine that the vehicle 202 may have stopped or be stationary for a time duration greater than a threshold time duration, based on the real-time vehicle location obtained from the GPS sensors/receivers 304d, 304e, the inputs obtained from the VCU 212, and/or the images obtained from the vehicle cameras 302. Responsive to determining that the vehicle 202 may be stationary for a time duration greater than the threshold time duration, the processor 248 may decrease the wiper speed to a fifth (lower) wiper speed (if both the windshield 242 and the road 104 may be wet) and/or the sampling frequency to a fifth (lower) sampling frequency. The processor 248 may reduce processor computational resources and vehicle battery power usage by reducing the wiper speed and the sampling frequency when the vehicle 202 may be stationary. In further aspects, in this case, the processor 248 may transmit a notification to the vehicle operator, via the user device 204 and/or the infotainment system 240, to disable or deactivate the “wetting detection mode” or auto-wiping vehicle feature if the vehicle operator desires the processor 248 to not move the wiper 244 and/or detect windshield wetting level. The vehicle operator may then disable the auto-wiping vehicle feature via the user device 204 or the infotainment system 240, responsive to receiving the notification. If the vehicle operator does not disable the auto-wiping vehicle feature, the processor 248 may continue to obtain inputs from the vehicle cameras 302 and the additional sensors 304 at the fifth sampling frequency and control wiper speed based on the obtained inputs.

Although the description above describes an aspect where the processor 248 determines the wetness level and controls the wiper speed based on inputs obtained from the vehicle cameras 302 and the additional sensors 304, in some aspects, the processor 248 may determine the wetness level and control the wiper speed based only on the inputs obtained from the vehicle cameras 302. Stated another way, the processor 248 may perform the operations mentioned above equally efficiently if the processor 248 has access to only the inputs obtained from the vehicle cameras 302, and may not have access to the additional sensors 304 described above.

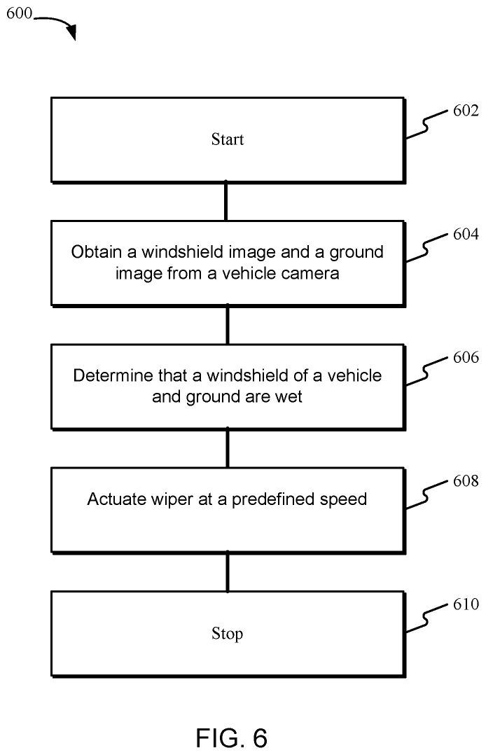

FIG. 6 depicts a flow diagram of an example method 600 to facilitate auto-wiping in accordance with the present disclosure. FIG. 6 may be described with continued reference to prior figures. The following process is exemplary and not confined to the steps described hereafter. Moreover, alternative embodiments may include more or less steps that are shown or described herein and may include these steps in a different order than the order described in the following example embodiments.

The method 600 starts at step 602. At step 604, the method 600 may include obtaining, by the processor 248, the windshield image and the ground/road image from the vehicle cameras 302. At step 606, the method 600 may include determining, by the processor 248, that the windshield 242 and the ground/road 104 may be wet based on the windshield image and the ground/road image. At step 608, the method 600 may include actuating, by the processor 248, the wiper 244 at a predefined speed (e.g., the first speed) responsive to a determination that both the windshield 242 and the ground/road 104 may be wet.

The method 600 may end at step 610.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A vehicle comprising:
a windshield;
a wiper configured to clean the windshield;
a vehicle camera configured to capture a windshield image and a ground image; and
a processor communicatively coupled with the wiper and the vehicle camera, wherein the processor is configured to:
obtain the windshield image and the ground image from the vehicle camera at a first predefined sampling frequency;
determine that the windshield and ground are wet based on the windshield image and the ground image; and
actuate the wiper at a first speed based on a determination that the windshield and the ground are wet.

2. The vehicle of claim 1, wherein the processor is further configured to determine that the vehicle is located outside a covered enclosure, wherein the processor actuates the wiper when the processor determines that the vehicle is located outside the covered enclosure.

3. The vehicle of claim 2, wherein the vehicle camera is further configured to capture a vehicle surrounding image, and wherein the processor determines that the vehicle is located outside the covered enclosure based on the vehicle surrounding image.

4. The vehicle of claim 2 further comprising a geolocation module configured to determine a real-time vehicle location, and wherein the processor determines that the vehicle is located outside the covered enclosure based on the real-time vehicle location.

5. The vehicle of claim 4, wherein the processor is further configured to:
determine that the vehicle is moving based on the real-time vehicle location; and
determine a first wetting level at a first timestamp and a second wetting level at a second timestamp based on the windshield image and the ground image obtained from the vehicle camera at the first predefined sampling frequency, responsive to a determination that the vehicle is moving.

6. The vehicle of claim 5, wherein the processor determines the first wetting level and the second wetting level based on at least one of: a droplet size on the windshield, a droplet shape on the windshield, water stream flow shape and size on the windshield and water level on the ground.

7. The vehicle of claim 5, wherein the processor is further configured to:
determine that the second wetting level is greater than the first wetting level; and
increase the first speed to a second speed responsive to a determination that the second wetting level is greater than the first wetting level.

8. The vehicle of claim 7, wherein the processor is further configured to increase the first predefined sampling frequency to a second predefined sampling frequency responsive to the determination that the second wetting level is greater than the first wetting level.

9. The vehicle of claim 7, wherein the processor is further configured to:
determine that the second wetting level is less than the first wetting level; and
decrease the first speed to a third speed responsive to a determination that the second wetting level is less than the first wetting level.

10. The vehicle of claim 9, wherein the processor is further configured to decrease the first predefined sampling frequency to a third predefined sampling frequency responsive to the determination that the second wetting level is less than the first wetting level.

11. The vehicle of claim 5 further comprising at least one of: a vehicle microphone and an external vehicle rain sensor.

12. The vehicle of claim 11, wherein the processor is further configured to:
obtain inputs from the vehicle microphone and the external vehicle rain sensor; and
obtain weather condition information from an external server based on the real-time vehicle location,
wherein the processor determines the first wetting level and the second wetting level based on the inputs obtained from the vehicle microphone and the external vehicle rain sensor, and the weather condition information.

13. The vehicle of claim 4, wherein the processor is further configured to:
determine that the vehicle is stationary for a time duration greater than a predefined threshold time duration based on the real-time vehicle location;
decrease the first speed to a fourth speed; and
decrease the first predefined sampling frequency to a fourth predefined frequency.

14. A method to facilitate auto-wiping, the method comprising:
obtaining, by a processor, a windshield image and a ground image from a vehicle camera at a first predefined sampling frequency;
determining, by the processor, that a windshield of a vehicle and ground are wet based on the windshield image and the ground image; and
actuating, by the processor, a wiper at a first speed based on a determination that the windshield and the ground are wet, wherein the wiper is configured to clean the windshield.

15. The method of claim 14 further comprising determining that the vehicle is located outside a covered enclosure, wherein actuating the wiper comprises actuating the wiper when the vehicle is located outside the covered enclosure.

16. The method of claim 15, wherein determining that the vehicle is located outside the covered enclosure comprises determining that the vehicle is located outside the covered enclosure based on a real-time vehicle location.

17. The method of claim 16 further comprising:
determining that the vehicle is moving based on the real-time vehicle location; and
determining a first wetting level at a first timestamp and a second wetting level at a second timestamp based on the windshield image and the ground image obtained from the vehicle camera at the first predefined sampling frequency, responsive to a determination that the vehicle is moving.

18. The method of claim 17 further comprising:
determining that the second wetting level is greater than the first wetting level; and
increasing the first speed to a second speed responsive to a determination that the second wetting level is greater than the first wetting level.

19. The method of claim 18 further comprising increasing the first predefined sampling frequency to a second predefined sampling frequency responsive to a determination that the second wetting level is greater than the first wetting level.

20. A non-transitory computer-readable storage medium having instructions stored thereupon which, when executed by a processor, cause the processor to:
obtain a windshield image and a ground image from a vehicle camera at a first predefined sampling frequency;
determine that a windshield of a vehicle and ground are wet based on the windshield image and the ground image; and
actuate a wiper at a first speed based on a determination that the windshield and the ground are wet, wherein the wiper is configured to clean the windshield.
